(19) United States
(12) Patent Application Publication
(10) Pub. No.: US 2015/0348084 A1
(43) Pub. Date: Dec. 3, 2015

(54) SYSTEM AND METHOD FOR AUTOMATICALLY DONATING PAYMENT CARD POINTS

(71) Applicant: L. Grant Lynd, Lakewood Ranch, FL (US)

(72) Inventor: L. Grant Lynd, Lakewood Ranch, FL (US)

(21) Appl. No.: 14/694,092

(22) Filed: Apr. 23, 2015

Related U.S. Application Data
(60) Provisional application No. 62/006,306, filed on Jun. 2, 2014.

(51) Int. Cl. G06Q 30/02; G06Q 30/08

(52) U.S. Cl. CPC G06Q 30/0226; G06Q 40/02; G06Q 30/08

(57) ABSTRACT

The present invention is a system and method for automatically transferring rewards earned from purchase transactions made using a rewards purchase card to organizations selected by the cardholder of the purchase card. Embodiments of the invention may be preconfigured by a third party or configured by the cardholder to allocate rewards to one or more organizations and also to the cardholder.

### CROSS-REFERENCE TO RELATED APPLICATION

This application claims priority to provisional application 62/006,306 filed on Jun. 2, 2014 and is incorporated by reference in its entirety as if fully recited herein.

### TECHNICAL FIELD

Exemplary embodiments of the present invention relate generally to a system and method for automatically crediting certain organizations with funds corresponding to rewards earned as the result of using credit or debit payment cards.

### BACKGROUND AND SUMMARY OF THE INVENTION

Credit and debit cards, collectively referred to as payment cards are an increasingly common method of purchasing goods and services. Due to the popularity of payment cards, many consumers carry more than one such card and often use these cards for convenience rather than the ability to purchase goods and services on credit. Thus, a consumer's choice of which card to use may be based upon more than the amount of available credit or interest rate charged on a balance maintained on the card. Purchase cards are generally issued by an issuing bank. The issuing bank determines features of the purchase card including the interest rate, billing information, and possible incentives offered to the consumer to encourage the use of the card. In addition to the issuing bank, purchase card transactions generally involve an acquiring bank and a purchase card network. Issuing banks, acquiring banks and purchase card networks receive a percentage of each transaction from the merchant in the form of what is generally referred to, in aggregate, as the discount rate. The discount rate takes the form of a surcharge taken from the amount of a transaction before payment to the merchant. For example, a cardholder may purchase goods or services from a merchant for $100. The $100 is added to any balance the cardholder may owe to the issuing bank. The issuing bank retains a percentage of the $100 and transmits the remaining funds to the receiving bank through the card network used to process the payment. The network also frequently retains a portion of the remaining funds. The receiving bank may also retain a small portion of the funds and deposits the remaining amount in the merchant's account. In this example, the deposited amount may be $96. Generally, the largest portion of the surcharge is retained by the issuing bank. In addition to a portion of the discount rate, an issuing bank may also receive interest on a balance carried by the cardholder. As may be apparent, the issuing bank has an incentive to encourage the use of the purchase cards it issues in order to receive a portion of the discount rate of each transaction as was previously noted.

As was described earlier, consumers may have large numbers of purchase cards from which to choose. In order to encourage the use of their cards, issuing banks frequently offer incentives in the form of rewards to encourage consumers to apply for and use purchase cards offered by the issuing bank. These rewards often take the form of airline flight credits, merchandise, or cash back offers. Purchase cards that offer these sorts of rewards are frequently referred to as “rewards cards.” When a consumer makes a purchase using a rewards card, the consumer may accumulate points, airline miles, or be offered “cash back” in the form of a payment or credit of a certain amount of funds depending upon the goods or services purchased.

As is well known, charitable organizations frequently rely on donations made by individuals and business organizations. A common form of donation is a direct gift from an individual or business to the charity in which the donation takes the form of one or more payments of money to the organization. Unfortunately, it is sometimes difficult to persuade individuals and businesses to make these direct gifts. It may be less challenging for such an organization to convince an individual or business to commit to a series of small donations. In particular, a series of repetitive donations that require no continuing decision on behalf of a consumer may be the most convenient for both the charity and donor.

What is needed is a system and method that allows a donor to make donations to a charity or other organization without having to actively make a decision at the time of each donation. As was described above with regard to rewards cards, such cards accumulate points, miles, or cash which may be redeemed by the cardholder. In an embodiment of the present invention, a system and method may automatically transfer all or a portion of the rewards earned by a cardholder as the result of the use of a rewards card. In certain embodiments of the invention, the system and method may be configured to transfer portions of accumulated rewards to a plurality of charities where the charities and amounts to be donated to each charity may be selected by the cardholder/donor. In other embodiments of the invention, in addition to all or a portion of accumulated rewards, the cardholder/donor may be able to select an additional amount to be donated where such amounts may be distributed across a predetermined period of time and be configured as one or more purchase transactions on a rewards card belonging to the donor. In still other embodiments of the invention, the issuing bank or other organization may provide the donor/cardholder and donee charities a tax record of amounts donated to each charity using an embodiment of the invention.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several figures refer to identical or equivalent features, and wherein:

FIG. 1 is a block diagram of an embodiment of the invention illustrating allocation of rewards points to a plurality of charities;

FIG. 2 is a block diagram of an embodiment of the invention illustrating a block diagram of a rewards allocation engine;

FIG. 3 is a flow chart of an embodiment of the invention illustrating a payment card holder configuring the points allocation process;

FIG. 4 is a flow chart of an embodiment of the invention illustrating a process of enrolling a charity to receive funds in an embodiment of the invention;

FIG. 5 is a flow chart of an embodiment of the invention illustrating a process of earning and allocating points to a plurality of charities; and

FIG. 6 is a block diagram illustrating an embodiment of the invention in which a cardholder/donor interacts with an application in communication with a rewards allocation engine.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions may be omitted for clarity and conciseness.

As used herein, the term “cardholder” is defined as an individual who possesses a rewards card that is enabled to utilize an embodiment of the invention. A cardholder may become a donor as a result of configuring an embodiment of the invention to transfer rewards points to one or more charities. As used herein, the term “acquiring bank” is defined as the financial institution to which a merchant submits credit card transactions for processing. The term “issuing bank” refers to the financial institution which issues a payment card, which may be a rewards card, to a customer. The issuing bank may determine the terms and conditions of a payment card, including the amount of rewards credits that a customer may earn by using a rewards card. As used herein, “points” may refer to rewards received as the result of purchasing goods or services using a rewards card. The received rewards may include, but are not limited to, credits, airline miles, merchandise, or cash equivalents.

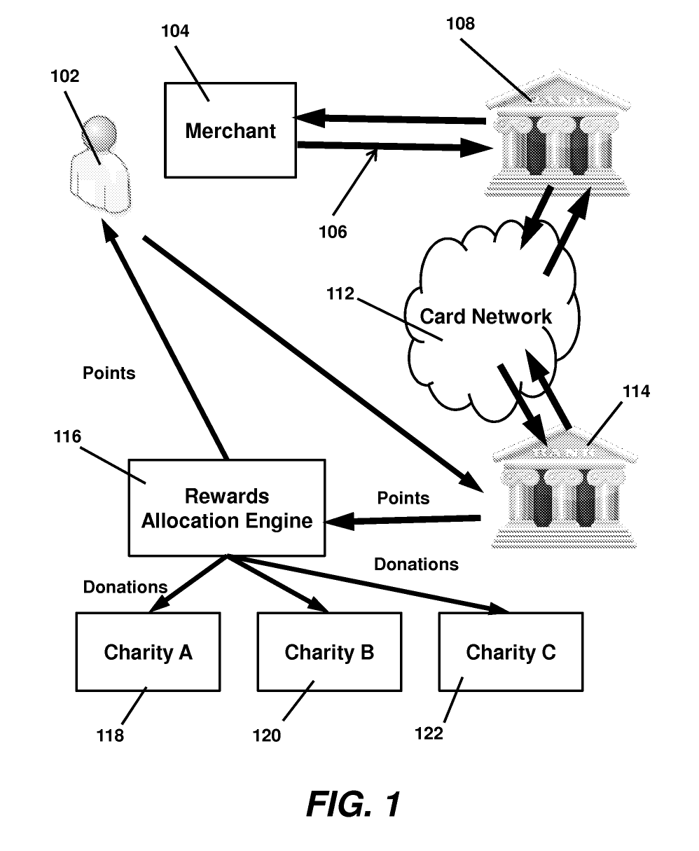

A diagram of a payment card processing network which includes a rewards allocation engine according to an embodiment of the invention is illustrated in FIG. 1. For clarity, the illustrated figure includes only the main components of the network as are necessary to explain the claimed invention. Those skilled in the art will understand that there may be a plurality of additional components in a payment card processing network. A cardholder 102 may purchase goods or services from a merchant 104. As is illustrated by the arrow 106, when the cardholder wishes to make a purchase, the merchant may submit an authorization request to the acquiring bank 108. The authorization request may be communicated using a card network 112 to the issuing bank 114. If the issuing bank approves the transaction, the approval is communicated back to the merchant 104. At a point later in time, the issuing bank may transfer funds in the amount of the purchase to the acquiring bank. The issuing bank may then credit the cardholder 102 with rewards points according to the agreement between the cardholder and the issuing bank (the cardholder agreement). These points may be in the form of a credit, airline miles, point values that can be exchanged for goods or services, or other items depending upon the terms of the cardholder agreement.

In an embodiment of the invention, a rewards allocation engine 116 may be configured to allocate points in a manner selected by the cardholder 102. As is illustrated in FIG. 1, rewards may be allocated to a plurality of charitable organizations 118, 120, 122 and to the cardholder 102. The rewards allocation engine need not necessarily allocate points directly to the cardholder as illustrated but instead may record them in a points account maintained by the issuing bank or other organization. This points account may be the same storage location in which the rewards points are stored in instances without the invention. In such an embodiment, the cardholder may redeem the points that remain allocated to the cardholder as they would be in a configuration without the invention. Even though the rewards allocation engine is illustrated as being located outside of the issuing bank 114 in FIG. 1, in certain embodiments of the invention, the rewards allocation engine may be located within the computational infrastructure of an issuing bank. Alternatively, the rewards allocation engine may be located externally, as would be the case when functions performed by the decision engine are provided by the computer systems of a third-party service provider.

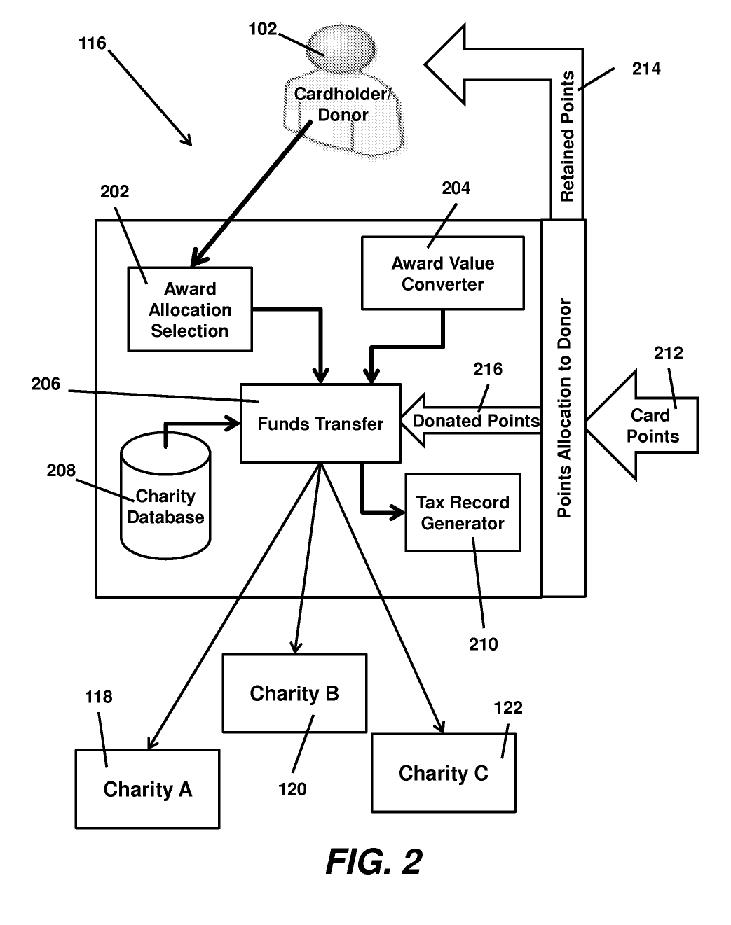

A diagram of the main components of an embodiment of the rewards allocation engine 116 is illustrated in FIG. 2. In an embodiment of the invention, the rewards allocation engine may be comprised of an award allocation selection function 202, an award value converter processor 204, a funds transfer processor 206, a charity database 208, and a tax record generator 210. Depending upon the implementation, an embodiment of the rewards allocation engine may receive card points from a computerized system at the issuing bank 114 or may be configured to retrieve those points from the issuing bank. In other embodiments of the invention, the functions described may be performed by various computerized devices and need not be consolidated into one engine or device as shown in FIG. 2.

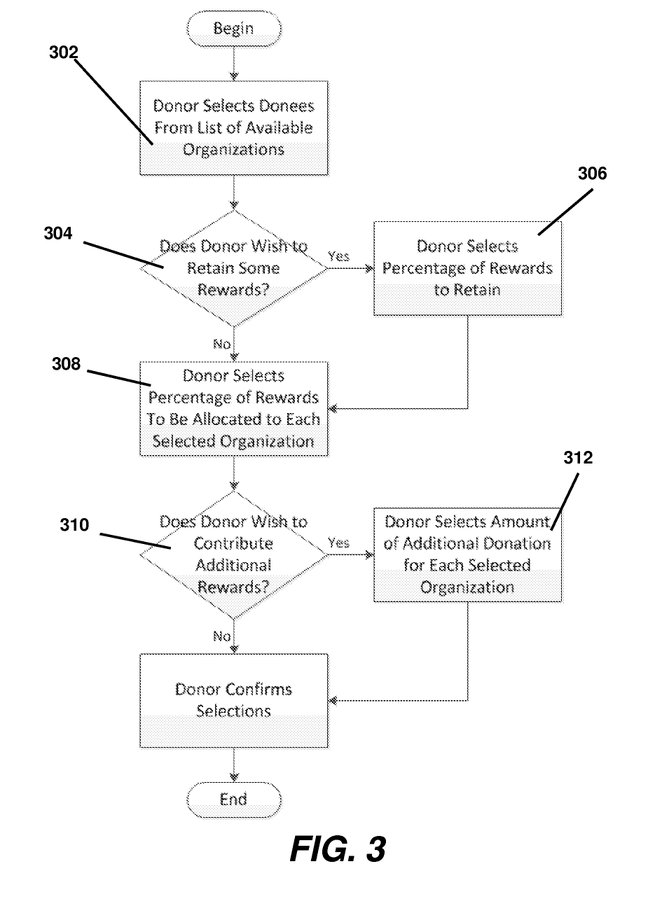

As is illustrated in FIG. 2, a cardholder may make point donation selections using an award allocation function 202 in order to determine which charities will receive point donations and how to allocate points if more than one charity is selected for donation. As is shown in the flow chart of FIG. 3, a cardholder/donor may select one or more donees from a list of available organizations 302. When the cardholder/donor has selected desired organizations, that donor may be presented with the option to retain a certain number or percentage of rewards for the donor's use 304 prior to allocating the remaining rewards points. The donor may select the amount or percentage to retain 306 and determine the percentages or amounts to allocate to the selected charities 308.

In some instances, a cardholder/donor may wish to donate an additional amount to one or more charities 310. In such an instance, the cardholder/donor may select the additional amount to be donated to one or more of the selected charities in step 312. In some embodiments of the invention, if such an additional donation is selected, the cardholder/donor may also select the frequency of the donation. In an exemplary embodiment, the cardholder/donor may desire to donate an additional fixed amount according to a predetermined schedule. For instance, a cardholder/donor may select an option to donate $25 every month to a charity. In an embodiment of the invention, a purchase transaction may be submitted to the issuing bank that reflects the desired donation and that amount may be added to any points values donated to the desired charity. Once such a selection has been made, the cardholder may be asked to confirm the selections 314 before they are stored for use by the rewards allocation engine 116.

Referring again to FIG. 2, as card point values 212 are retrieved or received by the rewards allocation engine 116, those points that the cardholder/donor wishes to retain may be removed from those to be processed by the rewards allocation engine and returned to the cardholder/donor by the rewards allocation engine as shown at 214. Even though the illustration shows the points flowing to the cardholder/donor, in some embodiments of the invention, the points may be returned to a storage location maintained by the issuing bank 114 or other organization. Points not retained by the cardholder 216 may be processed by an award value converter function 204 in order to establish a cash value for points that are not awarded as a dollar value. Embodiments of the invention may convert points into cash values using predetermined value agreements with an issuing bank. In other embodiments, points may be aggregated by the points decision engine 116 to allow the points to be converted to cash values using an auction or other sales process. Other embodiments of the invention may dispense with the awards value converter function and provide the points values directly to the charitable organization whereupon the charitable organization may choose to convert the points to a cash value or exchange them in some other manner as best suits the needs of the particular charity.

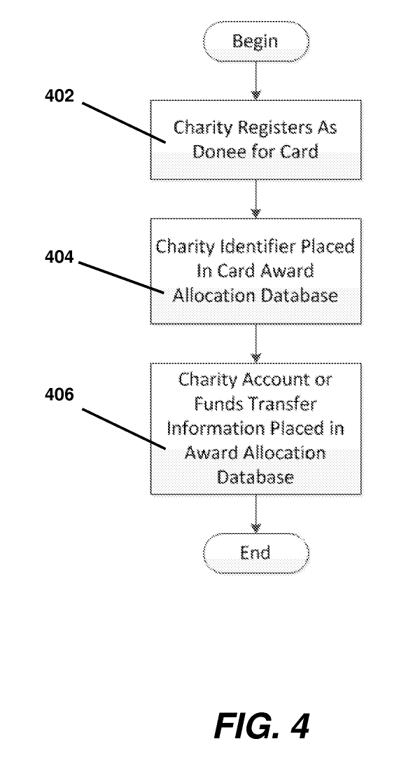

The funds transfer function 206 may be used to transfer converted awards values to charities selected by the cardholder/donor. In an embodiment of the invention, the funds transfer function may allocate points according to the charities and allocation amounts selected by the cardholder/donor during a rewards allocation selection process. In certain embodiments of the invention, a third-party, rather than the donor, may select the rewards allocation amounts. Such embodiments may allow the third party to offer a payment card product to donors that is pre-configured to allocate points to a charity selected by the third party. For example, using such an embodiment, a charitable organization may offer a purchase card to potential donors that is pre-configured to allocate a percentage of rewards to the charitable organization. In this example, the charity may adjust the allocations as its contribution goals are achieved to direct contributions to another goal. Once the charities and amounts have been identified, the funds transfer function may refer to a charity database 208 in order to determine how such funds should be transferred to the identified charities. A charity may register with an embodiment of the invention in a manner illustrated by the flowchart of FIG. 4. As is shown in step 402, a charity may register to be available for selection by a donor when that donor allocates rewards points to be donated as was described in the flowchart of FIG. 3. In some embodiments of the invention, an administrator may vet organizations wishing to register to ensure that they are actually charitable organizations. Certain embodiments of the invention may store descriptions of each charity in order to assist the cardholder/donor in his or her allocation process. It should be noted that even though the recipient of the donated points has been referred to herein as a charity, embodiments of the invention may be used to donate rewards points to organizations other than charities.

When a charity registers and is approved as may be required in embodiments of the invention, an identifier may be placed in a card reward allocation charity database 208 as illustrated in step 404. The identifier may be used during the donee selection process by the donor to identify and make decisions regarding which charities should receive donations from that particular donor. As was noted above, the charity may also be asked to provide a description of the charity which may be displayed during the selection and allocation process of FIG. 3. In step 406, information used to transfer the donated amounts may also be stored. Such information may comprise, bank routing and account information, wire transfer information, or a mailing address for depositing donated amounts in the form of checks. Referring again to FIG. 2, the charity database 208 is illustrated as a part of the rewards allocation engine 116. In other embodiments of the invention, the charity database may be centrally located and referenced by a plurality of rewards allocation engines using a computer network such as the internet. Such an embodiment may allow a plurality of issuing banks to utilize a plurality of rewards allocation engines while referencing a charity database that may be administered and maintained by a third party.

As is illustrated in FIG. 2, a funds transfer function may allocate and transfer points to a plurality of charities 118, 120, and 122. At a predetermined interval, a tax record generator function 210 may be used to generate tax documents required for submission by the cardholder/donor to various tax authorities. The tax record generator function may also be used to generate tax reporting materials for the charitable organizations receiving donations from cardholders via an embodiment of the invention.

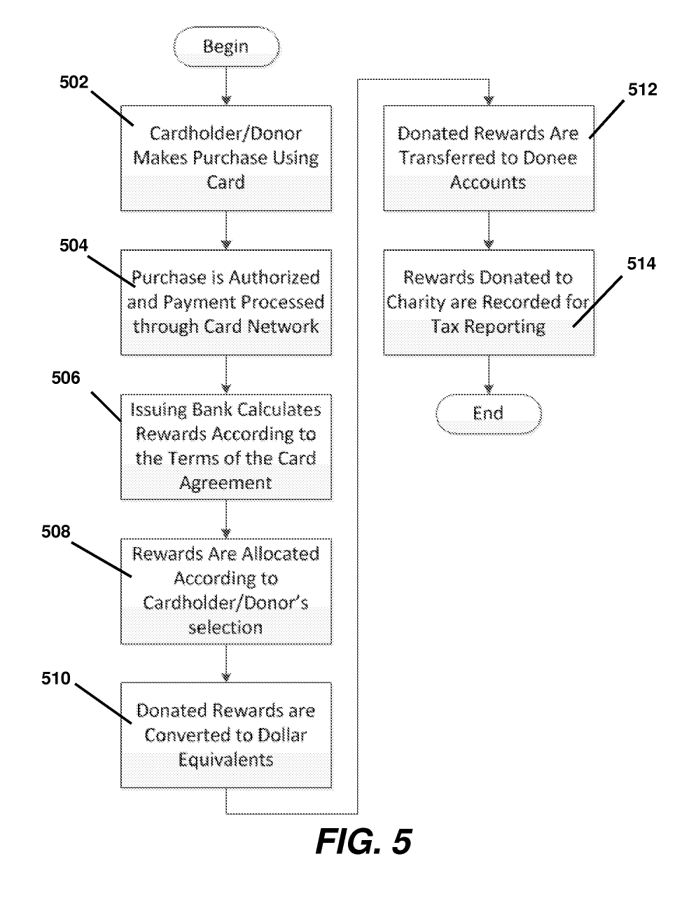

An illustration of the overall process of earning and allocating points using an embodiment of the invention is illustrated in the flowchart of FIG. 5. The illustrated process assumes that the cardholder/donor or an authorized third party has previously configured the donees and percentages of points to be allocated to those donees as was described previously in FIG. 3. In step 502, a cardholder/donor may make a purchase using a rewards card. As is illustrated in step 504, the purchase may be authorized and processed using known purchase card processing methods. In step 506, the issuing bank may calculate rewards amounts according to the terms of the rewards card agreement between the cardholder/donor and the issuing bank. The allocation of rewards to charities is shown in step 508. As was described earlier, a rewards allocation engine may receive points, determine how a cardholder wishes to allocate the points, and initiate the transfer of allocated points to the designated charities. If required, a conversion to cash values may be performed by an embodiment of the invention in step 510. Converted rewards amounts are transferred to donee(s) in step 512 and tax reporting is performed in step 514.

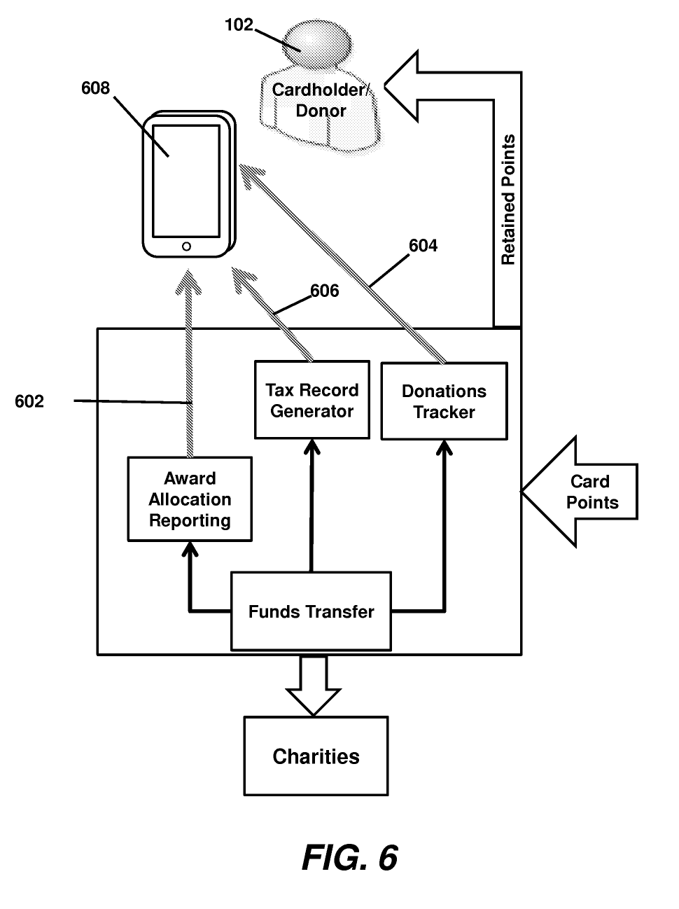

As is illustrated in FIG. 6, embodiments of the invention may be configured to report information such as, but not limited to, allocation percentages 602, allocation amounts during a period of time 604, and tax records 606. Such information may be communicated to a cardholder/donor 102 through a web page, electronic communications such as emails or text messages, or, as illustrated, through the use of a dedicated software program (App) running on a mobile computing device 608. Such an embodiment may be particularly useful in configurations where the cardholder/donor 102 is not the user configuring the allocation of points between the cardholder/donor and charities receiving the donated points.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A method of allocating accumulated rewards values earned using a purchase card comprising the steps of:
receiving an identifier corresponding to a purchase card which earns rewards as the result of purchases;
receiving identifiers representing a plurality of preselected recipient identifiers;
receiving a selection of at least one of the preselected recipient identifiers;
receiving an input selection corresponding to the allocation of rewards values amongst a group comprising a cardholder of the purchase card and the selected recipient identifiers; and
configuring a reward value allocation system to allocate rewards values according the receiving input selection.

2. The method of claim 1, wherein the plurality of received preselected recipient identifiers represent charitable organizations.

3. The method of claim 1, further comprising the steps of:
allocating rewards values earned by the purchase card using the rewards allocation system; and
distributing the allocated reward value to the selected recipients.

4. The method of claim 3, wherein the step of distributing is performed by the deposit of a cash value corresponding to a reward value into a bank account belonging to a selected recipient.

5. The method of claim 4, wherein the cash value is determined using a predetermined value agreement by an issuing bank of the purchase card.

6. The method of claim 4, wherein the cash value is determined by the steps of:
aggregating rewards values earned by a first purchase card with those earned by at least a second purchase card issued by the same issuing bank as the first purchase card;
offering the aggregated rewards values to a plurality of bidders and accepting the highest bid to arrive at an actual value of the aggregated rewards values;
exchanging the aggregated rewards values for a monetary amount equal to the highest auction bid offered in the auction process; and
determining a monetary value of a reward value by dividing the monetary amount by the number of rewards values aggregated.

7. The method of claim 3, further comprising the steps of:
storing a value representing a cumulative reward value allocated to a selected recipient; and
communicating a representation of the stored value to a cardholder to which the purchase card has been assigned.

8. The method of claim 3, wherein the step of distributing is performed by depositing the allocated rewards into an account maintained by the reward allocation system for the selected recipient.

9. The method of claim 3, wherein the allocated rewards are selected from a group that includes one or more of the following: points, dollar amounts, airline miles, merchant credits, merchandise, and services.

10. A system for allocating accumulated rewards values earned using a purchase card comprising:
a rewards allocation engine comprising:
a database of donees; and
a funds transfer processor;
software instructions, which when executed by the rewards allocation engine, cause the rewards allocation engine to:
receive an input corresponding to a selection of at least one donee from the database of donees;
receive an input selection corresponding to the allocation of rewards values earned using the purchase card among members of a group consisting of a cardholder of the purchase card and the selected donee(s);
receive a reward value representing rewards earned using the purchase card;
allocate the rewards values using the funds transfer processor according the receiving input selection; and
distributing portions of the allocated rewards values to the selected members of the group.

11. The system of claim 10, further comprising:
a rewards value converter processor; and
software instructions which cause the rewards value converter processor to receive allocated rewards values from the funds transfer processor and calculate a cash value representing the value of at least one of the allocated reward(s).

12. The system of claim 11, further comprising:
a tax record generator; and
software instructions which:
cause the tax record generator to store a value representing a cumulative cash value allocated to a selected recipient; and
communicate the stored value to the cardholder.

13. The system of claim 10, further comprising at least one reward storage account assigned to a donee and software instructions which cause the rewards allocation engine to store rewards allocated to the donee to a reward storage account assigned to that donee.

14. The system of claim 10, wherein the allocated rewards are selected from a group consisting of points, dollar amounts, airline miles, merchant credits, merchandise, and services.

15. A method of allocating accumulated rewards values earned using a purchase card comprising the steps of:
receiving an identifier corresponding to a purchase card which earns rewards as the result of purchases made using the purchase card;
receiving a plurality of preselected recipient identifiers;
receiving a selection of at least one of the preselected recipient identifiers;
receiving an input selection corresponding to the allocation of rewards values amongst a group comprising a cardholder of the purchase card and the selected recipient identifiers;
configuring a rewards value allocation system to allocate rewards values according to the received input selections;
allocating rewards values earned by the purchase card using the rewards allocation system;
distributing the allocated reward values to the recipients identified by the section of recipient identifiers by the deposit of a monetary value determined using a predetermined value agreement by an issuing bank of the purchase card into a bank account belonging to a selected recipient;
storing a value representing a cumulative rewards value allocated to a selected recipient; and
communicating an indication representing the stored value to a cardholder to which the purchase card has been assigned.

16. The method of claim 15, wherein the step of distributing is performed by depositing a number representing the number of allocated rewards into an account belonging to the selected recipient.

17. The method of claim 15, wherein rewards values are selected from a group that includes one or more of the following: points, dollar amounts, airline miles, merchant credits, merchandise, and services.
